(19) United States
(12) Patent Application Publication
(10) Pub. No.: US 2026/0253333 A1
(43) Pub. Date: Aug. 27, 2026

(54) MULTIMODAL LARGE LANGUAGE MODEL 3D GENERATION

(71) Applicant: Adobe Inc., San Jose, CA (US)

(72) Inventors: Yu Shen, Oakland, CA (US); Uttaran Bhattacharya, Sunnyvale, CA (US); Stefano Petrangeli, Mountain View, CA (US); Matheus Abrantes Gadelha, Amherst, MA (US); Gang Wu, San Jose, CA (US); Fadlullah Raji, San Jose, CA (US)

(73) Assignee: Adobe Inc., San Jose, CA (US)

(21) Appl. No.: 19/065,123

(22) Filed: Feb. 27, 2025

(51) Int. Cl. G06T 17/20; G06V 20/70

(52) U.S. Cl. CPC G06T 17/20; G06V 20/70

(57) ABSTRACT

Techniques related to multimodal large language model 3D generation are described. In an example, a processing device is operable to input an object description into a large language model that creates an initial compact graph representing an initial hierarchy of initial object attributes based on the object description. The processing device generates an initial object model based on the initial compact graph. The processing device inputs an object edit into the large language model that creates an updated compact graph representing an updated hierarchy of updated object attributes and replaces the initial object model with an updated object model generated based on the updated compact graph.

### BACKGROUND

Three-dimensional (3D) object modeling and digital content creation includes generating and modifying object models, also referred to as object representations, such as meshes and point clouds. Conventional 3D object modeling tools rely on manual editing or extensive expertise to generate and modify object models. Conventional approaches are tedious and time-consuming, potentially inhibiting iterative design workflows and presenting challenges for implementing precise model adjustments. Conventional modeling techniques often lack versatility and robustness based on limited support for more than one type of object model. Advanced modeling techniques, like procedural 3D modeling, implement a dynamic model adjustments based on modification of underlying parameters, which is challenging for novice users.

### SUMMARY

Techniques for generating and editing 3D objects using multimodal large language models are described. An example system includes a processing device that inputs an object description (e.g., natural language text) into a large language model trained to create an initial compact graph representing an initial hierarchy of object attributes inferred from the object description. The compact graph represents a simplified and efficient encoding of a procedural structure, geometric properties, and relationships of 3D surfaces. The compact graphs are interpretable as sets of geometric primitives combinable into 3D mesh representations, enabling flexible manipulation of object geometry and materials. The processing device generates an initial object model based on the initial compact graph. When an object edit (e.g., based on natural language text or user interface interactions) input is received, the large language model updates the initial model by creating an updated compact graph representing an updated hierarchy of object attributes that differs from the initial hierarchy of object attributes. The processing device then replaces or reconfigures the initial object model to implement an updated object model generated based on the updated compact graph. To improve generalization capabilities, the large language model is fine-tunable using synthetic training data generated by rendering multi-view images of 3D models, captioning them with a vision language model, and generating corresponding text descriptions. The approach enables efficient generation and modification of 3D models through natural language instructions, addressing limitations of conventional modeling techniques that produce static, non-editable representations. In variations, a user interface displays an object preview window with rendered images depicting views of the initial and updated object models. Parameter user interface controls enable users to refine an object edit to support custom and fine control attribute adjustments during the generating or editing processes.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description includes references to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques described herein related to multimodal large language model 3D generation.

FIG. 2a depicts a system architecture as an example implementation of modeling tool that is operable to implement techniques described herein related to multimodal large language model 3D generation.

FIG. 2b depicts a system as an example implementation of a generative model editor that is operable to apply techniques described herein based on multimodal large language model 3D generation.

FIG. 2c depicts a system as an example implementation of a training module that is operable to train at least one machine learning model based on multimodal large language model 3D generation.

FIG. 3 depicts a diagram of generative modeling examples created using techniques described herein related to multimodal large language model 3D generation.

FIG. 4 depicts a diagram of generative modeling examples created using techniques described herein related to multimodal large language model 3D generation.

FIG. 5 illustrates a parametric editing sequence of a procedural compact graph using techniques described herein related to multimodal large language model 3D generation.

FIG. 6 depicts a procedural compact graph for using techniques described herein related to multimodal large language model 3D generation.

FIG. 7 is a flow diagram depicting an algorithm as a step-by-step procedure, which is performable by a processing device to use multimodal large language model 3D generation.

FIG. 8 is a flow diagram depicting an algorithm as a step-by-step procedure, which is performable by a processing device to use multimodal large language model 3D generation.

FIG. 9 shows an example of a method for conditional media generation according to aspects of the present disclosure.

FIG. 10 shows a flow diagram depicting an algorithm as a step-by-step procedure for training a machine-learning model according to aspects of the present disclosure.

FIG. 11 illustrates an example system including various components of an example device usable as any type of computing device as described and/or utilized with reference to FIGS. 1-10 to implement examples of the techniques described herein.

### DETAILED DESCRIPTION

### Overview

Three-dimensional (3D) content creation and editing are prevalent in various industries, including entertainment, design, and manufacturing. While effective for initial creation, conventional approaches to generating and modifying 3D models present challenges when iterative design and precise modifications are desired.

Conventional approaches frequently depend on extensive manual intervention or expert-level knowledge of specialized software tools. Static representations, such as point clouds, meshes, or implicit representations are produced, which are challenging to modify once generated. Point clouds lack connectivity information, making targeted edits difficult, while meshes use complex re-meshing techniques or constraint search algorithms, even for simple modifications. Furthermore, conventional modeling tools lack compatibility across different types of 3D object representations, impacting robustness and versatility. Some advanced techniques, like procedural 3D modeling, allow for more dynamic adjustments by modifying underlying parameters of an object representation. However, procedural 3D modeling techniques depend on users having specialized knowledge, limiting accessibility for novice users.

Limitations of conventional 3D modeling solutions impact productivity and creative workflows. The lack of easily editable representations hinders efficient iteration and refinement of 3D assets, particularly for complex objects or scenes. When working with generative artificial intelligence models, for instance, objects are 3D scanned or created through other advanced techniques. The time-consuming nature of building an object model and applying manual edits has potential to introduce inconsistencies across different views of the 3D object, leading to prolonged design cycles and reduced creative exploration.

The inability to seamlessly work across various types of 3D representations restricts artists and designers from fully leveraging the advantages of different modeling technologies within a single project. As 3D content becomes increasingly complex and diverse, there is a growing demand for more flexible and intuitive editing capabilities that handle a wide range of object types and representations. Recent advancements in artificial intelligence and machine learning have shown promise in automating aspects of 3D content creation. However, conventional approaches still focus primarily on the initial generation of 3D models rather than providing comprehensive solutions for both generation and editing.

An example system (e.g., a content processing system that executes modeling tool) is described implementing techniques for generating and editing 3D models using large language models (LLMs). The system combines LLMs with a compact graph representation for generating and editing 3D models. The LLM integration enables efficient creation and modification of 3D content through natural language instructions, bridging the gap between high-level design intent and low-level geometric operations. The system addresses limitations of conventional modeling approaches by producing editable representations, significantly improving how users interact with and modify 3D content. The example system integrates a compact graph representation with LLMs to generate procedural 3D models that are readily modified by natural language, providing substantial improvements in flexibility and usability for both expert and novice users.

The example system includes a large language model trained to create and manipulate compact graphs representing 3D objects. The compact graphs encode a hierarchy of object attributes, allowing for intuitive generation and editing of 3D models. Unlike conventional methods that produce static representations such as point clouds or meshes, the example compact graph representations maintain the procedural nature of the 3D model while being more efficient in terms of storage and transmission. The approach enables parametric editing and enhances iterative design workflows by allowing users to make adjustments to 3D models through text commands or parameter controls.

The example system operates by first inputting an object description into the LLM, which generates an initial compact graph. The graph is then interpreted to produce a 3D mesh representation of the object. When users provide edit instructions, the LLM updates the compact graph in real-time, and the example system generates a modified 3D model based on changes. The process allows for rapid iteration and refinement of 3D designs without manual modeling or complex software interactions, a capability not typically found in conventional 3D modeling systems.

The example system's output includes both the 3D object models and a user interface for visualization and editing. The interface displays rendered images of the 3D models and provides parameter controls for adjusting object attributes. The combination of visual feedback and intuitive controls enables users to efficiently explore design variations and make modifications to 3D models. The system's ability to generate and edit 3D content through natural language instructions is useful for industries such as entertainment, design, and manufacturing, where rapid prototyping and iterative design are beneficial.

To enhance performance and generalization capabilities, the example system employs a multi-stage training process. The LLM is initially trained on a dataset of text descriptions paired with corresponding compact graphs. The LLM is then fine-tuned using synthetic training data generated through a multi-step process involving rendering multi-view images of 3D models, captioning the images with a vision language model, and generating corresponding text descriptions. The approach significantly improves the example system's ability to handle out-of-distribution object categories and ensures consistent outputs across a range of 3D modeling tasks. By maintaining multi-view consistency and accurately capturing 3D spatial relationships, the example system overcomes many of the limitations associated with traditional 2D-based approaches to 3D content creation and editing, addressing issues of inconsistency that arise in conventional modeling workflows.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Production Environment

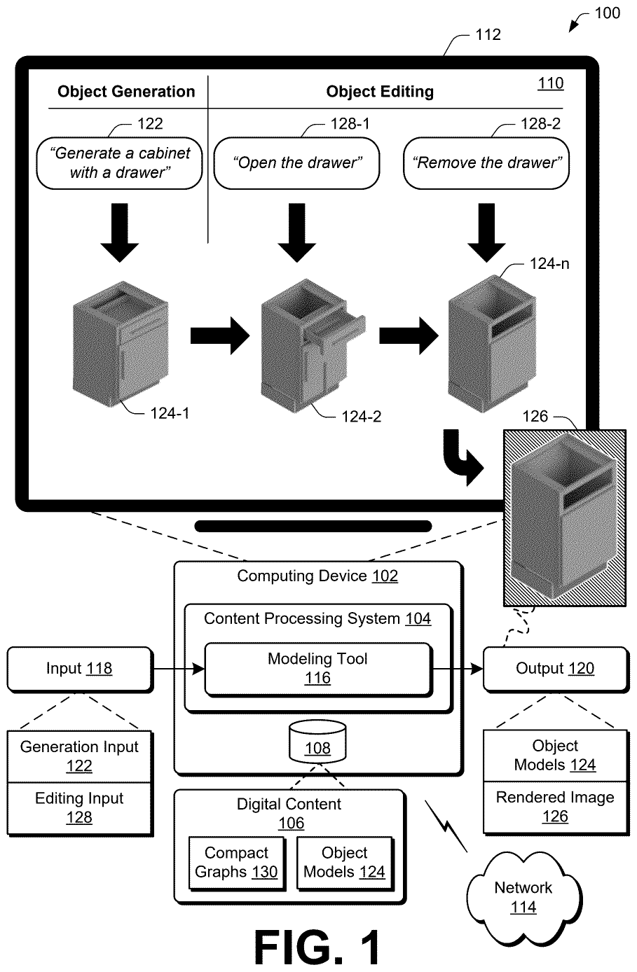

FIG. 1 is an illustration of a digital medium environment 100 in an example implementation that is operable to employ techniques described herein related to multimodal large language model 3D generation. The environment 100 includes a computing device 102, which is configurable in a variety of ways.

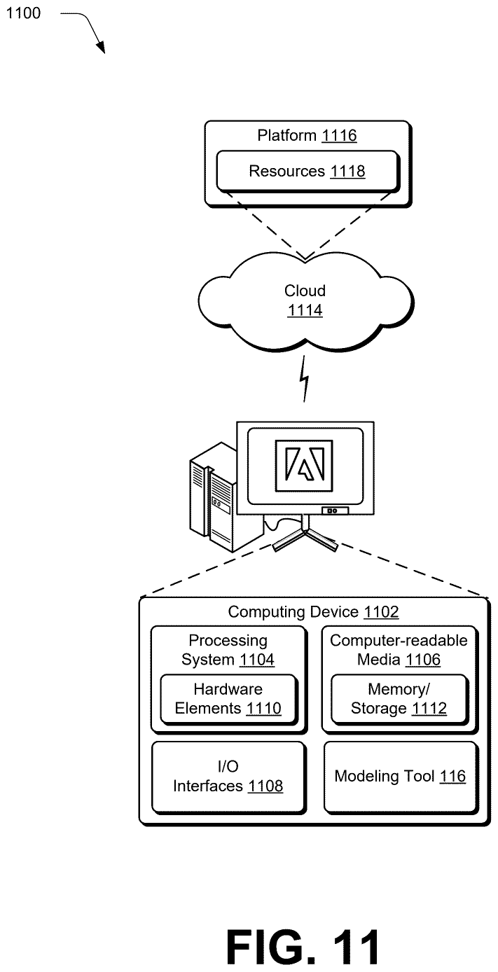

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 11.

The computing device 102 is illustrated as including a content processing system 104. The content processing system 104 is implemented at least partially in hardware of the computing device 102 to process and transform digital content 106, which is illustrated as being maintained in storage 108 of the computing device 102. Such processing includes creation of the digital content 106, modification of the digital content 106, and rendering or re-rendering of the digital content 106 for presentation in a user interface 110, e.g., for output by a display device 112. Although illustrated as implemented locally at the computing device 102, functionality of the content processing system 104 is also configurable in whole or in part through functionality available via the network 114, such as part of a web service or “in the cloud”.

The content processing system 104 incorporates a modeling tool 116 for processing digital content 106. The modeling tool 116 executes data processing tasks by receiving input 118 and generating output 120. The modeling tool 116 processes the input 118 to perform 3D object generation and editing using large language models. The modeling tool 116 is trained on a dataset of text descriptions paired with compact graph representations of 3D objects, enabling the content processing system 104 to generate and modify 3D models through natural language instructions, without being limited by static representations.

The input 118 to the modeling tool 116 is depicted as including generation input 122 and editing input 128. The generation input 122 refers to a text-based input (e.g., typed text, transcribed text, optical recognition text) describing a 3D object to be generated, for example, “Generate a cabinet with a drawer.” The editing input 128 refers to text-based instructions for modifying an existing 3D model, such as “Open the drawer” or “Remove the drawer.” The natural language inputs are processed through the user interface 110 through intuitive user interface controls, enabling users to generate and edit object models 124 without having specialized software knowledge or consuming extended amounts time and additional resources to manipulate complex geometric structures.

The modeling tool 116 processes the input 118 to create and modify the object models 124. As depicted in FIG. 1, the object models 124 include an initial model 124-1, an intermediate model 124-2, and an updated model 124-n, representing the progression of a 3D model through various states based on user inputs. The initial model 124-1 shows a closed cabinet, the intermediate model 124-2 displays the cabinet with an open drawer, and the updated model 124-n presents the cabinet with the drawer removed. The progression from the initial model 124-1 to the updated model 124-n demonstrates the capability of the modeling tool 116 to generate the initial object model 124-1, and then introduce precise targeted modifications based on natural language instructions that cause creation of the intermediate object model 124-2 and eventually the updated model 124-n.

The output 120 generated by the modeling tool 116 includes both the object model 124 and a rendered image 126 of the final model. The rendered image 126 provides a visual representation of the 3D model, allowing users to review the results of generation and editing instructions in real-time. Near immediate user interface feedback enables efficient iterative design processes and is obtained efficiently by manipulating the compact graphs 130 and avoiding time-consuming rendering steps between edits. The modeling tool 116 includes a user interface component, displayed on the display device 112, that provides both object generation and object editing interfaces. As demonstrated in other examples described and illustrated in the additional figures, the user interface 110 is configurable to include parameter controls for adjusting object attributes, allowing users to refine the generated or edited 3D models in other ways than natural language.

The modeling tool 116 uses compact graphs 130 for storing information used to generate the object models 124. The compact graphs 130 encode the procedural structure, geometric properties, and relationships of 3D surfaces in a simplified and efficient format. Unlike conventional approaches that produce static mesh or point cloud representations to facilitate attribute edits, the compact graphs 130 maintain the procedural nature of the object models 124, while being more efficient in terms of storage and transmission. The compact graphs 130 foster parametric editing, allowing users to make adjustments to 3D models through text commands or parameter controls without requiring manual modeling or complex software interactions.

As explained in greater detail below, at least one large language model is integrated in the modeling tool 116 to create and manipulate these compact graphs 130. When processing the generation input 122, the large language model creates an initial compact graph 130 representing an initial hierarchy of object attributes inferred from the text description. The modeling tool 116 then interprets the compact graph 130 to generate the initial object model 124-1. When receiving editing input 128, the large language model updates or regenerates the compact graph 130, creating a modified hierarchy of object attributes that reflects the requested changes. This updated graph is then used to generate the intermediate object model 124-2 or eventually, the updated model 124-n, depending on the sequence of edits.

Also explained in greater detail below, the modeling tool 116 utilizes a multi-stage training process. The large language model is initially trained on a dataset of text descriptions paired with corresponding compact graphs to generate and manipulate the compact graphs 130 for diverse object types. Then, the large language model is fine-tuned using synthetic training data generated through a process involving rendering multi-view images of 3D models, captioning them with a vision language model, and generating corresponding text descriptions, including out-of-distribution object categories not present in the initial training dataset. Once trained, the modeling tool 116 is configured to generate and edit the digital content 106 through natural language instructions, bridging the gap between high-level design intent and low-level geometric operations. The multi-stage training enables the modeling tool 116 to maintain multi-view consistency and captures 3D spatial relationships.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture of Multimodal Large Language Model 3D Generation

The following discussion describes multimodal LLM 3D generation techniques that are implementable utilizing the previously described systems and devices. Aspects of each of the procedures are implemented in hardware, firmware, software, or a combination thereof. The procedures are shown as a set of blocks that specify operations performed by one or more devices and are not limited to the orders shown for performing the operations by the respective blocks.

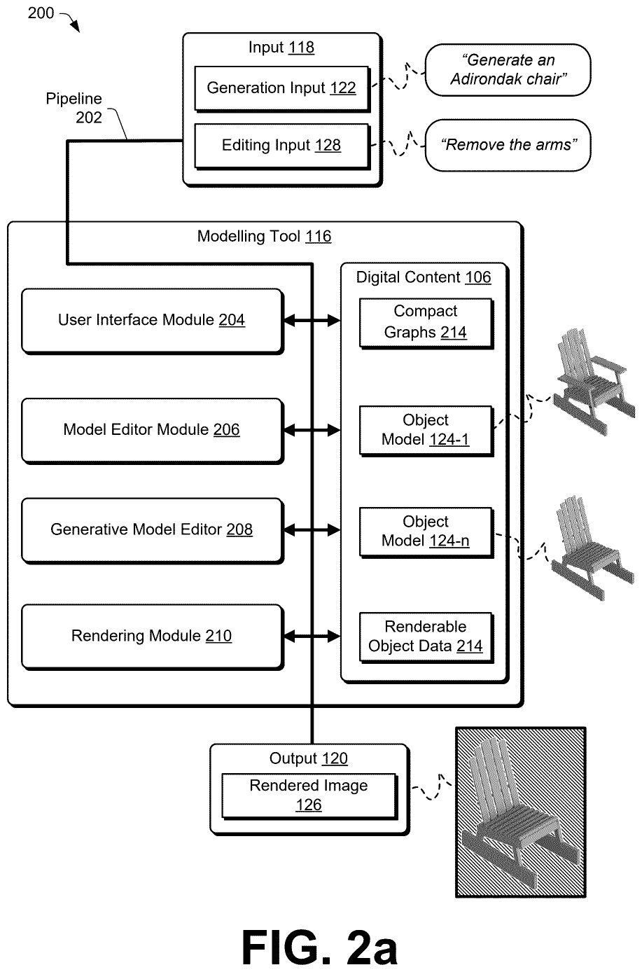

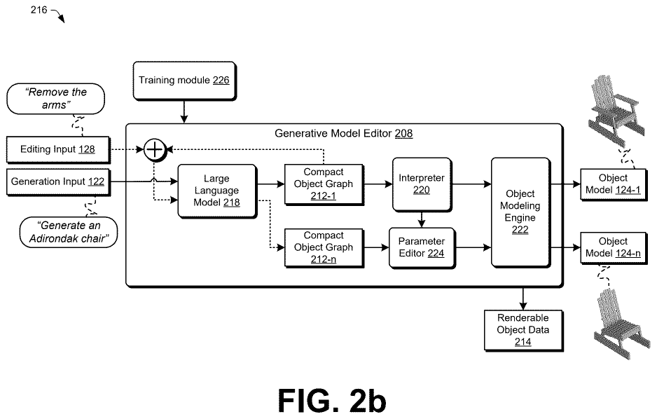

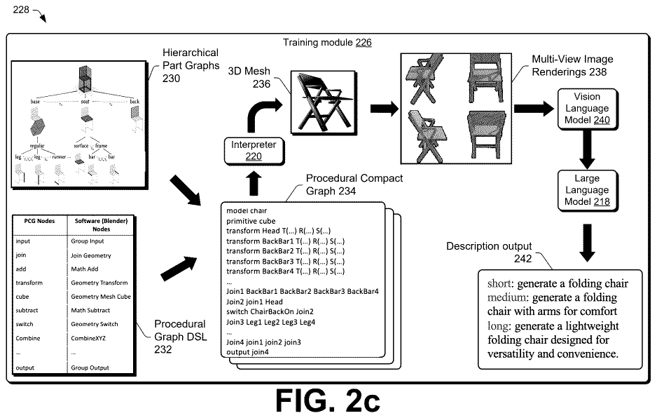

FIG. 2a depicts a system architecture 200 as an example implementation of a modeling tool that is operable to implement techniques described herein related to multimodal large language model 3D generation. The system architecture 200 illustrates an implementation of the modeling tool 116 of the content processing system 104, shown in greater detail than in FIG. 1.

By integrating large language models with procedural compact graph representations and an efficient rendering pipeline, the system architecture 200 offers improvements over conventional 3D modeling approaches. The architecture 200 provides a more intuitive, flexible, and efficient method for generating and editing complex 3D models, addressing long-standing challenges in the field of computer graphics and 3D content creation, and achieving performance improvements in terms of generation quality and editing speed.

In the illustrated example, the system architecture 200 includes a processing pipeline 202 that processes the input 118 and generates the output 120, demonstrating an example workflow for generating and editing the digital content 106, including the object models 124, using natural language instructions interpreted from the input 118. The modeling tool 116 receives the generation input 122 and the editing input 128 as part of the input 118. In one example scenario, a user of the computing device 102 interacts with the modeling tool 116 to generate or edit the object model 124-1. The user interacts with the user interface 110 for inputting the generation input 122 (e.g., typing “Generate an Adirondak chair”) or the editing input 128 (e.g., typing “Remove the arms”).

The system architecture 200 includes a user interface module 204 that facilitates user interactions with the user interface 110. The user interface module 204 enables the user in the above scenario, for example, to type at a keyboard or use voice-to-speech recognition through a microphone to describe to the modeling tool 116 text-based instructions (e.g., the generation input 122 and the editing input 128). The user interface module 204 converts user interface selections to text prompts, enhancing flexibility and allowing uniform processing of both visual selections and text-based inputs. In aspects, the user interface module 204 displays parameter user interface controls enabling users of the modeling tool 116 to refine an object edit to support custom and fine control attribute adjustments during the generating or editing processes. For example, after generating the initial object model 124-1, the user interface 110 displays sliders for adjusting a height or width of the chair, or other attributes. The parameter controls allow users to make precise modifications to enhance corresponding text instructions interpreted from the input 118. The user interface module 204 facilitates receiving user inputs that cause the rendered images 126 displayed on the display device 112 to visualize different viewing angles and perspectives of the resulting object models 124, enabling intuitive interactions. In presenting the rendered image 126, the user interface module 204 enhances real-time editing capability of the modeling tool 116 by providing seemingly immediate visual feedback to support efficient iterative design.

Upon receiving the input 118, the object modeling engine 222 prepares the initial object model 124-1 or processes editing instructions to create the updated object model 124-n. The object modeling engine 222 is operatively coupled to a generative model editor 208, which utilizes one or more large language models trained to interpret natural language inputs and generate or modify compact graphs 212 representing 3D objects. The object model editor 206 is operatively coupled to a generative model editor 208, which utilizes one or more large language models trained to interpret natural language inputs and generate or modify compact graphs 212 representing 3D objects. The compact graphs 212 comprise nodes representing geometric primitives such as cubes, spheres, cylinders, and planes, as well as operations for combining and modifying these primitives. These primitives serve as the building blocks for constructing complex 3D models, allowing for efficient representation and manipulation of object geometry. The detailed implementation of the generative model editor 208 will be described in FIG. 2b. The use of the compact graphs 212, including procedural compact graphs, as an intermediate representation of the object models 124 allows for efficient storage and transmission of 3D modeling data forward and back through the pipeline 202, addressing limitations of conventional approaches that rely on static mesh or point cloud representations.

The compact graphs 212 are example data structures that encode the procedural structure, geometric properties, and relationships of 3D surfaces in a simplified and efficient format. The compact graphs 212 enable parametric control over the object models 124, facilitating more flexible and intuitive editing. As examples of the compact graphs 130, the compact graphs 212 maintain the parametric nature of the 3D models while being more efficient in terms of storage and transmission compared to the object models 124 and other representations, such as meshes. The compact graphs 212 enable parametric editing, allowing users to make adjustments to the object models 124 through text commands or parameter controls without requiring manual modeling or complex software interactions.

In variations, when processing the editing input 128, the generative model editor 208 creates an updated compact graph 212 by modifying the initial hierarchy or the initial object attributes of the existing compact graph 212. The generative model editor 208 performs this modification in response to inputting both the editing input 128 and the existing compact graph 212 into the large language model within the generative model editor 208. For example, if the initial compact graph 212 represents a chair with arms, and the editing input 128 is “Remove the arms”, the generative model editor 208 modifies the compact graphs 212 to remove the nodes and attributes related to the chair arms, resulting in an updated compact graph 212 representing a chair without arms. Directly manipulating the compact graph 212 to modify attributes, rather than modifying the object models 124 directly, is less computationally intensive.

The rendering module 210 is responsible for converting the compact graphs 212 into the renderable object data 214, including visual representations of the object models 124. The rendering module 210 generates the renderable object data 214 by analyzing the object models 124, which is then displayed in the user interface 110 or output as the rendered images 126. The rendering process generates the rendered images 126 from the renderable data 214 by accounting for lighting, materials, and other visual properties to create representations of the object models 124. The real-time visualization capability supported by the rendering module 210 enables users to immediately see the results of generation and editing instructions, facilitating an iterative design process that is more efficient than conventional modeling techniques.

FIG. 2b depicts a system 216 as an example implementation of the generative model editor 208 that is operable to apply techniques described herein based on multimodal large language model 3D generation. The system 216 includes at least one large language model 218 that processes both generation input 122 and editing input 128. A large language model refers to an artificial intelligence system (e.g., one or more neural networks) trained on substantial amounts of text data to understand and generate human-like text. In the context of 3D modeling, large language models enable natural language interfaces for creating and editing 3D content. Examples of large language models suited for use as the large language model 218 include GPT-3, BERT, T5, and XLNet. The models have demonstrated capabilities in natural language understanding and generation suited for interpreting and translating user instructions into 3D modeling operations.

The rendering module 210 enhances multi-view consistency, maintaining coherent 3D structures across different viewpoints. As shown in FIG. 2a, the rendering module 210 processes the compact graphs 212 to generate renderable object data 214. The renderable object data 214 captures views of the initial object model 124-1 and updated object model 124-n from multiple angles. In FIG. 2b, the object modeling engine 222 interfaces with the rendering module 210 to produce consistent 3D meshes based on the compact graph representations. The multi-view consistency allows users to evaluate generated and edited models from various perspectives, as demonstrated by the rendered images 126 displayed in the user interface 110 on the display device 112.

In variations, the user interface module 204 manages the user interface 110 by causing the display device 112 to present an object preview window with rendered images 126 generated for depicting views of the initial object model 124-1, the intermediary object model 124-2, and the updated object model 124-n. The rendering module 210 generates the renderable data 214 that captures views of the initial object model 124-1 or the updated object model 124-n. The user interface module 204 outputs the rendered image 126 based on the renderable data 214 for display at the display device 112. The rendering process of the rendering module 210 allows users to evaluate the appearance of their designs from multiple angles and under different lighting conditions. In variations, the system architecture 200 uses the ULIP (Unified Language and Image Pre-training) score to evaluate the alignment between the input 118 (e.g., text prompts) and the output 120 (e.g., generated object models 124 and rendered images 126), improving quality.

The large language model 218 facilitates intuitive interactions with complex 3D data structures, which enables intuitive generation and editing of 3D models through natural language instructions, bridging the gap between high-level design intent and low-level geometric operations. The large language model 218 is trained to create and manipulate compact graphs representing 3D objects, addressing limitations of conventional approaches that produce static, non-editable representations. The large language model 218 translates natural language instructions into graph operations that define 3D geometry and structure. For instance, the generation input 122 “Generate an Adirondak chair” is interpreted to generate a compact graph 212 with nodes representing the seat, back, arms, and legs, along with spatial relationships. The editing input 128, such as “Remove the arms”, modifies relevant node parameters in the compact graph 212 by adding, deleting, renaming, or rearranging the nodes in the hierarchy of the compact graph 212.

When processing the generation input 122, the large language model 218 creates an initial compact graph 212-1 representing an initial hierarchy of object attributes inferred from the generation input 122. The interpreter module 220 then converts the compact graph 212-1 into instructions or commands for causing an object modeling engine 222 to generate an initial object model 124-1. The multi-step process of graph generation followed by interpretation and creation allows for efficient storage and manipulation of 3D model data, improving upon conventional approaches that attempts to edit mesh or point cloud representations directly. For instance, if the generation input 122 “Generate an Adirondak chair”, the large language model 218 generates a compact graph 212-1 with nodes representing the seat and back as square shapes, and two arm components, and two leg components, along with their spatial relationships and dimensions.

For editing operations, the large language model 218 takes the editing input 128 and the existing compact graph 212-1 as inputs to produce an updated compact graph 212-n. The updated graph 212-n represents a modified hierarchy of object attributes that reflects the requested changes. The parameter editor 224 converts the updated graph 212-n into instructions or commands for causing an object modeling engine 222 to generate an updated object model 124-n. The parameter editor 224 for example generates updated instructions or commands based on the updated graph 212-n that cause the object modeling engine 222 to generate the updated object model 124-n. The approach enables real-time, parametric editing of 3D models without manual modeling or complex software interactions. Continuing the chair example, if the editing input 128 is “Make the back rounded at the top instead of square,” the large language model 218 modifies the relevant nodes in the updated graph 212-n to change the shape of the back from square to rounded near the top, while maintaining the leg structures and omitting the arms. The real-time editing capability allows for rapid iteration and refinement of 3D designs.

When processing the editing input 128, the large language model 218 creates an updated compact graph 212-n by modifying the initial hierarchy or the initial object attributes of the existing compact graph 212-1. The modification occurs in response to inputting both the editing input 128 and the existing compact graph 212 into the large language model 218. For example, if the initial compact graph 212-1 represents a chair with arms, and the editing input 128 states “Remove the arms,” the large language model 218 modifies the compact graph 212-1 to remove the nodes and attributes related to the chair's arms, resulting in the updated compact graph 212-n representing a chair without arms.

The object modeling engine 222 operates in generation and editing processes. The engine 222 interprets the compact graphs 212 produced by the large language model 218 and converts the graphs 212 into the renderable data 214, e.g., renderable 3D mesh representations, and the object models 124. The engine 222 handles geometric primitives and operations encoded in the compact graphs, allowing for the creation of complex 3D structures from graph representations. The approach enables the system to handle a range of object categories, including out-of-distribution examples not seen during initial training. The object modeling engine 222 interfaces with the rendering module 210 to output the object models 124 and the renderable object data 214 used to produce consistent 3D views from meshes or other representations generated from the compact graph representations. The multi-view consistency allows users to evaluate generated and edited models from various perspectives, as demonstrated by the rendered images 126 displayed in the user interface 110 on the display device 112.

To enhance the generative modeling system 216 performance and generalization capabilities, a training module 226 operates within the generative modeling system 216. The module 226 implements a multi-stage training process that improves the large language model 218 ability to handle diverse object categories and maintain consistency across various 3D modeling tasks. The multi-stage training process includes fine-tuning using synthetic training data generated from multi-view images and captions, significantly improving the generative modeling system 216 ability to handle out-of-distribution object categories. The detailed implementation of this training process will be described in FIG. 2c.

FIG. 2c depicts a training system 228 as an example implementation of the training module 226. The training system 228 is operable to train the generative modeling system 216 and the system architecture 200 to implement techniques related to multimodal large language model 3D generation. This training system 228 enhances the performance of the components described in FIG. 2a and FIG. 2b, particularly the large language model 218 and the generative model editor 208.

The training system 228 configures the training module 226 to process training data through multiple stages to learn to create generative instructions for 3D model creation. This multi-stage process significantly improves the system's ability to handle diverse object categories and maintain consistency across various 3D modeling tasks, directly enhancing the capabilities of the components described in FIG. 2a and FIG. 2b.

To illustrate a training scenario, consider the following example of generating and editing a folding chair model. The training module 226 incorporates several processing components arranged in a sequential workflow, demonstrating the transformation of geometric data into natural language descriptions used for model generation and modification. The multi-stage process, which includes rendering multi-view images of 3D models, captioning the images with a vision language model, and generating corresponding text descriptions, significantly enhances the generative modeling system 216 ability to handle diverse object categories and maintain consistency across various 3D modeling tasks.

The process begins on the left side of the training module 226 with the hierarchical part graphs 230 component, which represents the structure of a folding chair, breaking down the chair components into a tree-like hierarchy. The hierarchical part graphs 230 are combined with a procedural graph DSL (Domain Specific Language) 232, which defines the mapping between the hierarchical components and software-specific implementations. The combination produces a procedural compact graph 234, which defines the structure and parameters of the 3D folding chair model represented by a 3D mesh 236. The compact graph representation significantly reduces code complexity compared to traditional 3D modeling approaches.

The interpreter module 220 then processes the procedural compact graph 234 to produce the 3D mesh 236 of the folding chair. The training module 226 processes the 3D mesh 236 and input parameters through the interpreter module 220, which converts the procedural compact graph 234 into multi-view image renderings 238. The renderings show different perspectives of the 3D mesh 236, displaying various views of the folding chair. The use of multi-view renderings ensures that the system captures comprehensive 3D spatial relationships, addressing issues of inconsistency that arise in conventional modeling workflows.

Following the interpretation stage, the rendering module 210 creates the multi-view image renderings 238 of the folding chair from multiple angles. The renderings are then processed by a vision language model 240 within the training module 226, which analyzes the renderings to generate image captions describing the visual characteristics of the model. The vision language model 240, which may be implemented as a pre-trained Contrastive Language Image Pre-training neural network model, generates image embeddings for the multi-view images and text embeddings for a set of candidate captions, selecting the appropriate captions based on similarities between the embeddings.

After caption generation, the captions are processed by a large language model 218 that produces generative instructions at different levels of detail, including short, medium, and long descriptions. The generative model editor 208 uses the instructions to create and modify compact graphs 212 representing the folding chair. The approach enables the system to generate diverse and detailed instructions, ranging from concise summaries to comprehensive specifications, enhancing the system's ability to handle a wide range of user inputs and modeling scenarios.

Once the compact graphs 212 are created or modified, the object modeling engine 222 interprets the graphs to generate initial object models 124-1 and updated object models 124-n of the folding chair. The user interface module 204 then displays rendered images 126 of the models and provides controls for user interaction. The object modeling engine 222 interfaces with the rendering module 210 to produce consistent 3D views from meshes or other representations generated from the compact graph representations, allowing users to evaluate generated and edited models from various perspectives.

The training module 226 arranges the components in a linear flow from left to right, with connections between each processing stage. The process demonstrates how the system transforms abstract representations into concrete 3D models through multiple processing stages, enabling both generation and editing of complex objects like folding chairs. The linear arrangement of components facilitates efficient data flow and processing, allowing for seamless integration of various AI models and techniques in the 3D generation pipeline.

The system architecture 200 described in FIG. 2a, the generative modeling system 216 detailed in FIG. 2b, and the training system 228 explained in FIG. 2c work together to form a trained machine learning based system that is operable by one or more processing devices of the computing device 102 to perform multimodal large language model 3D generation. The system architecture 200 provides the overall framework, the generative modeling system 216 handles generation and editing operations, and the training system 228 trains the generative modeling system 216 through multi-stage training. This integrated approach enables intuitive, efficient, and high-quality 3D model generation and editing across a wide range of object categories.

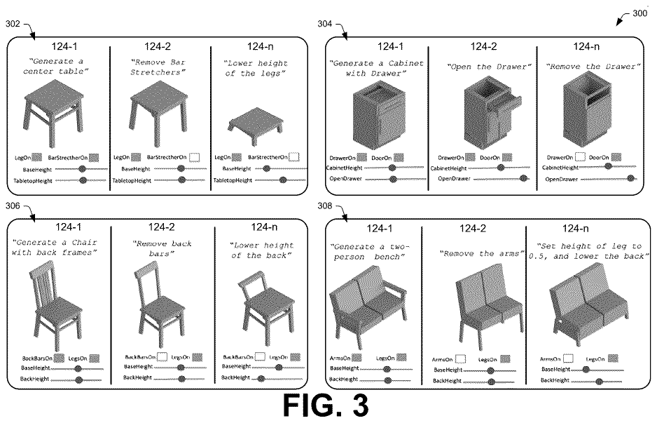

FIG. 3 depicts a diagram of generative modeling examples 300 created using techniques described herein related to multimodal large language model 3D generation. The examples 300 include four scenarios demonstrating generation and editing capabilities for various furniture pieces, illustrating the system's ability to create and manipulate 3D object models based on text inputs.

The table generation example 302 demonstrates creating and modifying a center table. The user interface module 204 displays an object preview window with rendered images depicting views of the initial object model 124-1, intermediate object model 124-2, and updated object models 124-n, along with respective sets of parameter user interface controls. The content processing system 104 receives an object description as generation input 122, causing the large language model 218 to create the initial compact graph 212-1 representing an initial hierarchy of object attributes of the center table. The object modeling engine 222 then generates the initial object model 124-1 based on the initial compact graph 212-1 by applying one or more initial geometric transformations.

The parameter user interface controls are dynamically updateable based on attributes defined in the initial compact graph 212-1. For instance, when the large language model 218 creates the initial compact graph 212-1, included attributes are BaseHeight, TabletopHeight, LegOn, and BarStretcherOn. The user interface module 204 then generates corresponding slider controls for BaseHeight and TabletopHeight, and toggle switches for LegOn and BarStretcherOn, directly reflecting the structure and parameters encoded in the compact graph 212-1.

When editing input 128 is received, such as instructions to remove bar stretchers and lower leg height, the large language model 218 creates an updated compact graph 212-n representing an updated hierarchy of object attributes. The user interface 110 displays a preview of the updated model 124-n to reflect an attribute hierarchy based on the compact graph 212-n. User inputs at the parameter user interface controls are interpreted as an editing input 128. For example, if the user adjusts the BaseHeight slider from 30 inches to 25 inches, the user interface module 204 interprets as editing input 128 describing an editing operation that is sent to the large language model 218. The large language model 218 then updates the compact graph 212-1, modifying the BaseHeight attribute in the hierarchy. The object modeling engine 222 processes the updated graph 212-n, applying new geometric transformations to generate an updated object model 124-n with shorter legs. The rendering module 210 creates new renderable object data 214, allowing the user interface module 204 to display the updated table in the preview window.

The cabinet generation example 304 depicts the creation and modification of a cabinet with drawers. The user interface module 204 presents parameter user interface controls for CabinetHeight and OpenDrawer, as well as toggles for DrawerOn and DoorOn. The controls are generated based on the attributes in the initial compact graph 212-1 for the cabinet. For example, if the compact graph 212-1 includes a Boolean attribute for DrawerOn, the user interface module 204 creates a corresponding toggle switch. When a user interacts with these controls, such as switching the DrawerOn toggle from “on” to “off”, the system interprets as an editing input 128. The large language model 218 processes this input to update the compact graph 212-1, removing the drawer nodes from the object hierarchy. The object modeling engine 222 then generates an updated object model 124-n based on this modified graph 212-n, resulting in a cabinet without drawers. The rendering module 210 creates new renderable object data 214, allowing the user interface module 204 to display the updated cabinet in the preview window.

The chair generation example 306 demonstrates the creation and modification of a chair with back frames. The user interface module 204 displays parameter user interface controls for BaseHeight and BackHeight, with toggles for BackBarOn and LegOn. The controls correspond to the attributes defined in the initial compact graph 212-1 for the chair. For instance, if the compact graph 212-1 includes a numeric attribute for BackHeight, the user interface module 204 generates a slider control with appropriate minimum and maximum values derived from the graph 212-1. A specific editing example involves a user moving the BackHeight slider to increase the height of the chair's back. The system interprets this slider movement as an editing input 128, updating the BackHeight attribute in the compact graph 212-1. The object modeling engine 222 then applies new geometric transformations based on the updated graph 212-n, resulting in a chair model 124-n with a taller back. The rendering module 210 generates new renderable object data 214, enabling the user interface module 204 to display the modified chair in the preview window.

The bench generation example 308 illustrates the generation and editing of a two-person bench. The user interface module 204 presents parameter user interface controls for BaseHeight and BackHeight, as well as toggles for ArmsOn and LegOn. The controls are generated based on the attributes in the initial compact graph 212-1 for the bench. For example, the ArmsOn toggle corresponds to a Boolean attribute in the graph 212-1 that determines the presence or absence of arms on the bench. An example of user input interpretation involves toggling the ArmsOn switch from “on” to “off”. The system processes this as an editing input 128, causing the large language model 218 to update the compact graph 212-1 by removing the arm nodes from the object hierarchy. The object modeling engine 222 then generates an updated object model 124-n based on the modified graph 212-n, producing a bench without arms. The rendering module 210 creates new renderable object data 214, allowing the user interface module 204 to display the updated bench in the preview window.

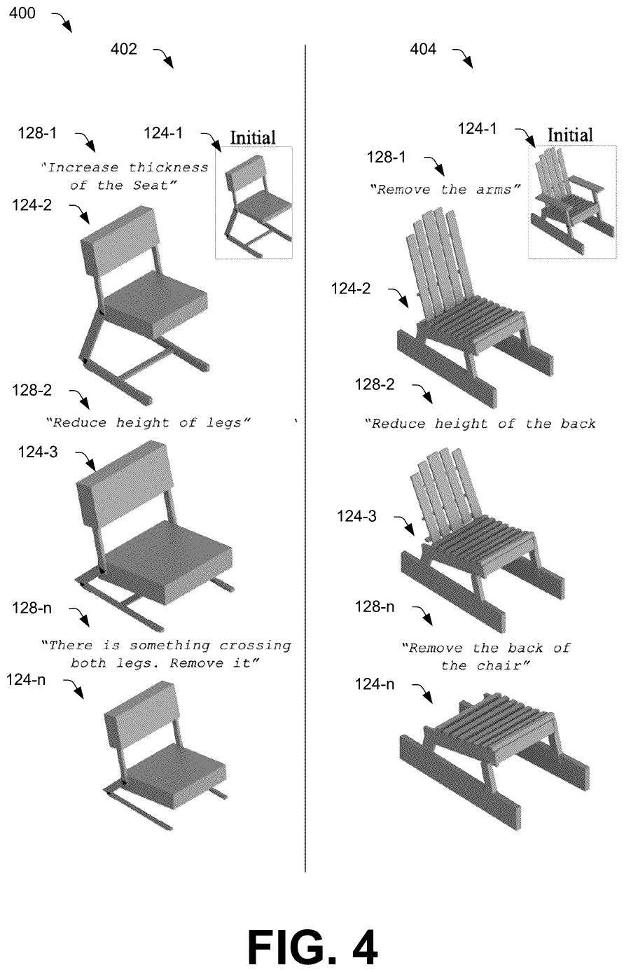

FIG. 4 illustrates generative modeling examples 400 showing two sequences of three-dimensional chair modifications including a basic chair sequence 402 on the left and a deck chair sequence 404 on the right. The basic chair sequence 402 begins with an initial object model 124-1 showing the basic chair with an original back and seat. Following intermediate editing input 128-1 “Increase thickness of the seat,” the sequence 402 shows an intermediate object model 124-2 of the basic chair with a thickened seat cushion. After other editing input 128-2 “Reduce height of legs,” the sequence 402 displays other object model 124-3 with shortened legs. The sequence 402 concludes with final editing input 128-n “There is something crossing both legs. Remove it” and shows updated object model 124-n with the cross-support removed.

The deck chair sequence 404 starts with initial object model 124-1 depicting a complete deck chair with arms and back. Following intermediate editing input 128-1 “Remove the arms,” the sequence 404 shows intermediate object model 124-2 representing the deck chair without armrests. After other editing input 128-2 “Reduce height of the back,” the sequence displays another object model 124-3 of the deck chair with a lowered backrest. The sequence 404 concludes with final editing input 128-n “Remove the back of the chair” and shows the updated object model 124-n of the deck chair with the backrest removed.

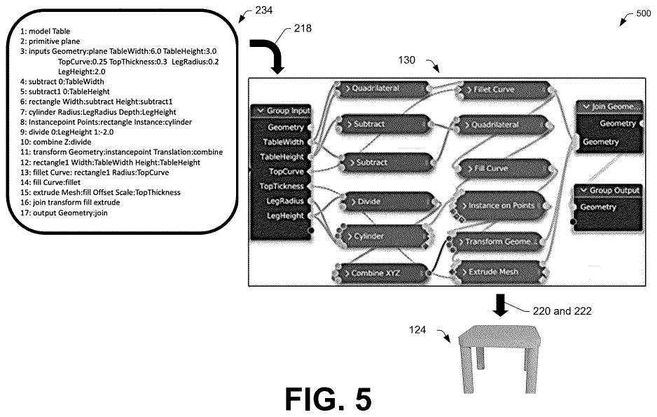

FIG. 5 illustrates a system diagram of a parametric editing sequence 500 showing the generation and editing of the object models 124. A large language model 218 processes input to generate a procedural compact graph 234. The procedural compact graph 234 connects to an interpreter module 220 which translates the graph representation into a format compatible with an object modeling engine 222. The object modeling engine 222 processes the interpreted data to generate object models 124.

The parametric editing sequence 500 that demonstrates how compact graphs 130 and 212 enable modifications to update existing object models. The compact graphs 130 and 212 preserve the hierarchical structure and relationships between object components while facilitating adjustments to specific parameters.

The diagram depicts the flow of information from the initial generation through the editing process. The large language model 218 processes natural language input to create or modify the procedural compact graph 234, which then flows through the interpreter module 220 and object modeling engine 222 to produce the final object models 124.

The components are arranged to show the sequential processing of data, with the large language model 218 at the start of the pipeline 202, followed by graph processing and interpretation stages, and concluding with the object modeling engine 222 that produces the rendered output.

The compact graphs 130 and 212 comprise nodes representing geometric primitives and operations for combining and modifying the geometric primitives. The nodes include elements such as cylinder nodes, rectangle nodes, point instance nodes, transform nodes, fillet nodes, fill nodes, extrude nodes, and join nodes. The object attributes in the compact graphs include geometric properties, material properties, or both geometric and material properties of the object models 124. The compact graphs 130 and 212 enable efficient storage and manipulation of 3D model data, improving upon approaches that attempt to edit mesh or point cloud representations directly.

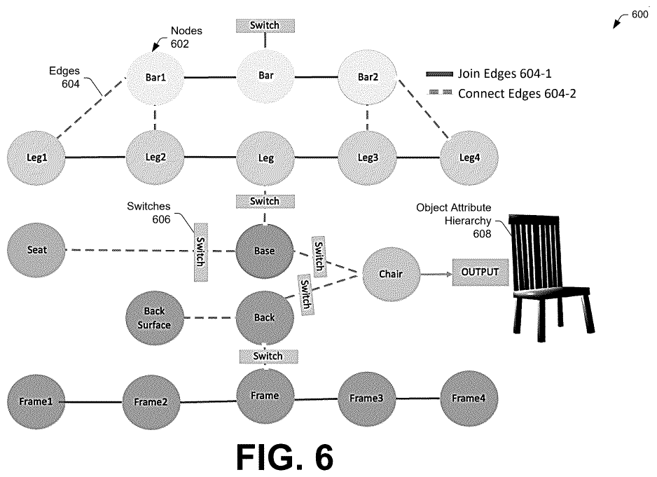

FIG. 6 depicts a procedural graph system 600 for representing object attributes and relationships. The procedural graph system 600 includes multiple graph nodes 602 arranged in three parallel horizontal branches representing different components of an object. The graph system 600 is an example of the compact graphs 130 and the compact graphs 212 as discussed above.

The graph nodes 602 are interconnected through join edges 604-1, shown as solid lines, and connect edges 604-2, shown as dashed lines. The top branch contains nodes labeled “Bar1,” “Bar,” and “Bar2” connected to nodes “Leg1” through “Leg4.” The middle branch includes nodes for “Seat,” “Base,” and “Back Surface” connected to a “Chair” node. The bottom branch contains nodes labeled “Frame1” through “Frame4.”

Graph switches 606 are positioned at junction points within the system, allowing for activation or deactivation of different paths through the graph. These switches are represented as small rectangular elements connected to nodes such as “Bar,” “Base,” “Back,” and “Frame.”

The procedural graph system 600 culminates in an object attribute hierarchy 608, shown on the right side of the diagram. This hierarchy represents the output structure, illustrated with a chair icon, demonstrating how the various nodes and connections combine to define the object representation.

The join edges 604-1 and connect edges 604-2 work together to establish relationships between different components, with join edges 604-1 representing direct connections and connect edges 604-2 indicating associative relationships between nodes. The arrangement of nodes and edges creates a structured representation that defines both the physical components and relationships within the object model.

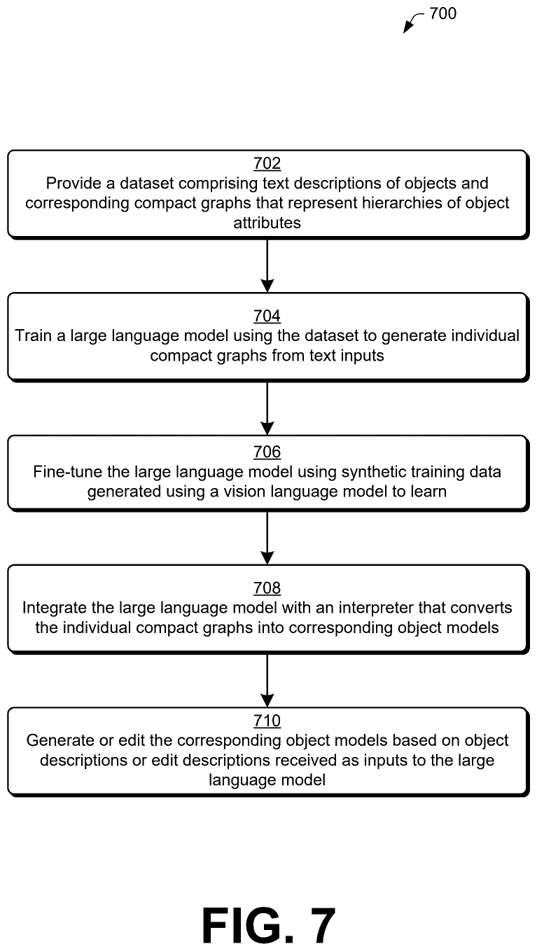

FIG. 7 is a flow diagram depicting an algorithm as a step-by-step procedure, which is performable by a processing device to use multimodal large language model 3D generation. In various examples, the process 700 is performed by the computing device 102, the content processing system 104, the modeling tool 116, and so forth, alone or in combination with performing aspects of a process 700, as depicted in FIG. 7.

The process 700 begins at block 702, where a dataset comprising text descriptions of objects and corresponding compact graphs representing hierarchies of object attributes is provided. The training module 226, for instance, collects a diverse dataset of text descriptions paired with compact graph representations of 3D objects, encoding procedural structures, geometric properties, and relationships of 3D surfaces on the processing device 102.

The process 700 then proceeds to block 704, where a large language model is trained using the dataset to generate individual compact graphs from text inputs. For example, the training module 226 processes the collected dataset to train the large language model 218 to create compact graphs 212 based on natural language descriptions. The training module 226 directs the training process to ensure the large language model 218 correctly interprets text inputs and generates appropriate compact graph representations.

Following block 704, the process 700 moves to block 706, where the trained language model is fine-tuned using synthetic training data generated using a vision language model. Fine-tuning with the training module 226 directs the generation of synthetic training data through a multi-step process involving rendering multi-view images of 3D models, captioning the images with a vision language model 240, and generating corresponding text descriptions using the large language model 218, or a different large language model, a separate large language model. The training module 226 guides the fine-tuning process, ensuring improved performance on out-of-distribution object categories.

The process 700 then advances to block 708, where the fine-tuned language model is integrated with an interpreter that converts the individual compact graphs into corresponding object models. The training module 226 implements the integration of the fine-tuned large language model 218 with the interpreter module 220, enabling the conversion of compact graphs 212 into renderable object data 214 and object models 124.

The process 700 concludes at block 710, where the corresponding object models are generated or edited based on object descriptions or edit descriptions received as inputs to the fine-tuned language model. The generative model editor 208 processes natural language inputs to create or modify compact graphs 212, which are then interpreted by the object modeling engine 222 to produce initial object models 124-1 or updated object models 124-n.

Throughout the training process, the synthetic training data is generated by rendering multi-view images of three-dimensional models, captioning the multi-view images using the vision language model 240, and generating text descriptions corresponding to the captions using the large language model 218. The training module 226 controls the generation of synthetic data, implementing strategies to create diverse and comprehensive training examples. The captioning process includes, for example, generating image embeddings for the multi-view images and text embeddings for a set of candidate captions using a pre-trained Contrastive Language Image Pre-training neural network model, selecting captions based on similarities between the embeddings.

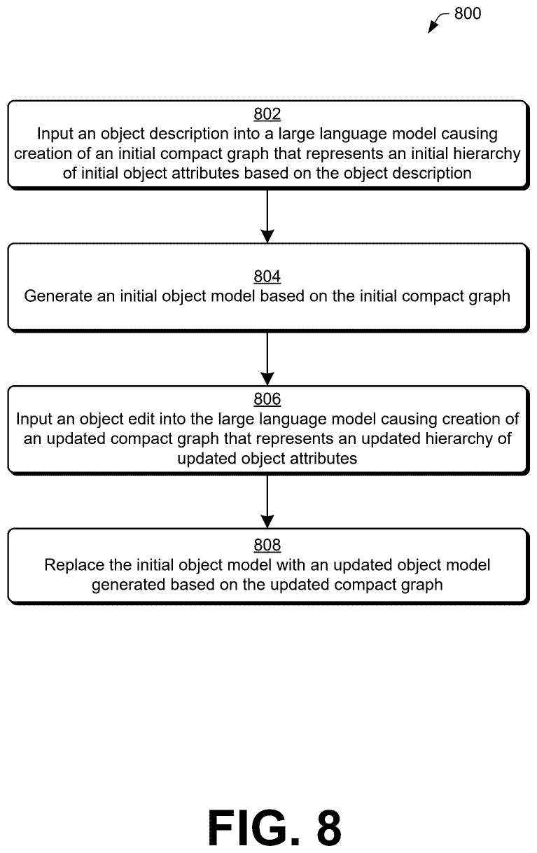

FIG. 8 is a flow diagram depicting an algorithm as a step-by-step procedure, which is performable by a processing device to use multimodal large language model 3D generation. In various examples, the process 800 is performed by the computing device 102, the content processing system 104, the modeling tool 116, and can be performed alone or in combination with performing aspects of a process 800, as depicted in FIG. 8.

The process 800 begins at block 802, where an object description is input into a large language model. The generative model editor 208, for instance, receives a text-based description of a three-dimensional object through the user interface module 204. The large language model 218 processes the input to create an initial compact graph representing an initial hierarchy of initial object attributes based on the object description.

The process 800 then proceeds to block 804, where an initial object model is generated based on the initial compact graph. For example, the object modeling engine 222 interprets the initial compact graph to produce a three-dimensional mesh representation of the described object. The object modeling engine 222 applies one or more initial geometric transformations to convert the initial compact graph into the initial object model.

Following block 804, the process 800 moves to block 806, where an object edit is input into the large language model. The user interface module 204 receives a text-based instruction or parameter adjustment describing a modification to the initial object model. The large language model 218 processes the object edit to create an updated compact graph representing an updated hierarchy of updated object attributes.

The process 800 then advances to block 808, where the initial object model is replaced with an updated object model generated based on the updated compact graph. The object modeling engine 222 interprets the updated compact graph by applying one or more updated geometric transformations to convert the updated compact graph into an updated three-dimensional mesh representation.

Throughout the process, the user interface module 204 displays an object preview window including rendered images depicting views of the initial and updated object models. The user interface module 204 also presents parameter controls indicating adjustable attributes of the object models. The parameter controls are dynamically updated based on the attributes defined in the compact graphs. User inputs received via the parameter controls are interpreted as object edits for modifying the object models.

The compact graphs comprise nodes representing geometric primitives and operations for combining and modifying the geometric primitives. The nodes include elements such as cylinder nodes, rectangle nodes, point instance nodes, transform nodes, fillet nodes, fill nodes, extrude nodes, and join nodes. The object attributes in the compact graphs include geometric properties, material properties, or both geometric and material properties of the object models.

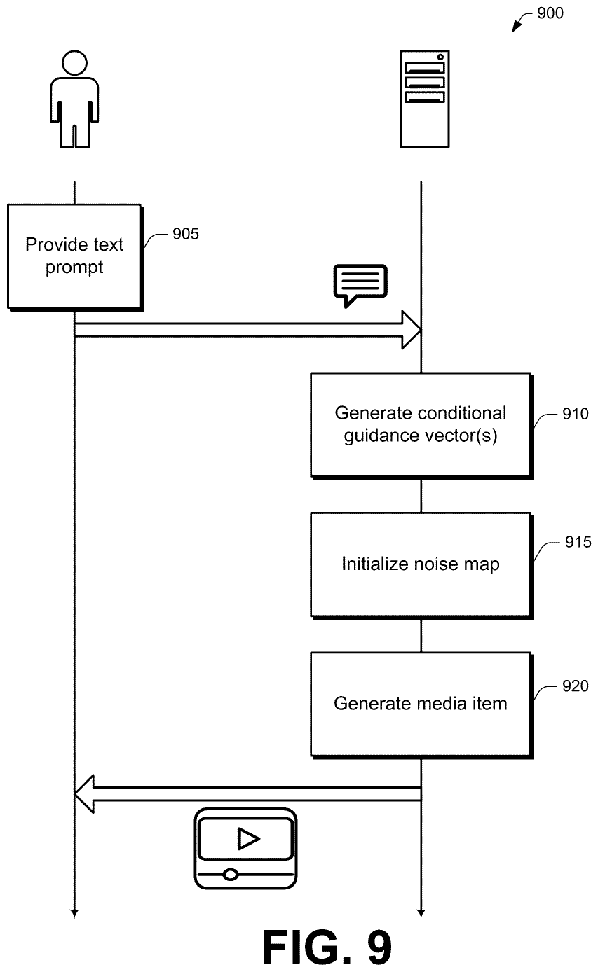

FIG. 9 shows an example of a process 900 for conditional media generation according to aspects of the present disclosure. In some examples, process 900 describes an operation of the generative model editor 208 as a component of the modeling tool 116 described with reference to above. In some examples, these operations are performed by a system including a processor executing a set of codes to control functional elements of an apparatus such as the content processing system 104 of the computing device 102 described in FIG. 1.

Additionally or alternatively, steps of the process 900 may be performed using special-purpose hardware. Generally, these operations are performed according to the methods and processes described in accordance with aspects of the present disclosure. In some cases, the operations described herein are composed of various sub steps or are performed in conjunction with other operations.

At operation 905, a user provides a text prompt describing content to be included in a generated media item. For example, a user may provide the prompt “a person playing with a cat.” In some examples, guidance can be provided in a form other than text, such as via an image, a sketch, or a layout, as shown in FIG. 2a.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model, as illustrated in FIG. 2b.

At operation 915, a noise map is initialized that includes random noise. The noise map may be in a pixel space or a latent space. By initializing a media item with random noise, different variations of a media item including the content described by the conditional guidance can be generated, similar to the process shown in FIG. 2c.

At operation 920, the system generates a media item based on the noise map and the conditional guidance vector. For example, the media item may be generated as the digital content 106, as depicted in FIG. 2a.

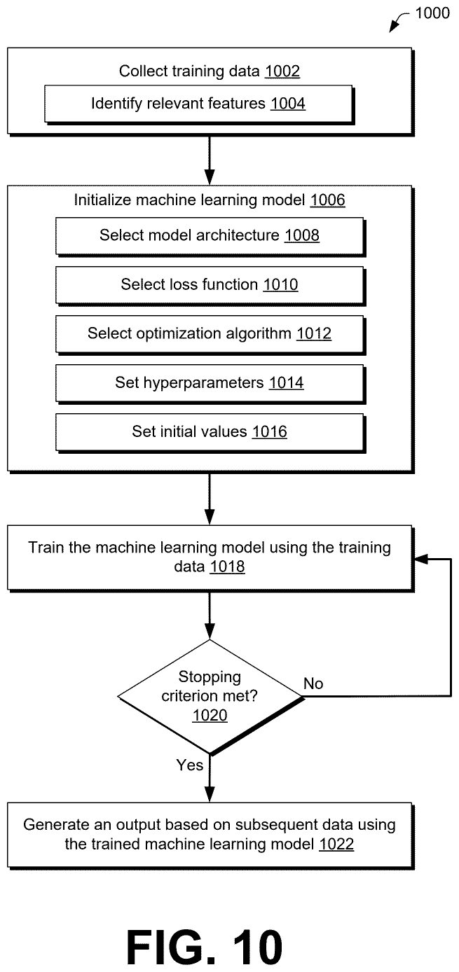

FIG. 10 is a flow diagram depicting an algorithm as a step-by-step procedure 1000 in an example implementation of operations performable for training a machine-learning model. In at least one example, the procedure 1000 describes an operation of the training module 226 described for configuring the generative model editor 208 as described above. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1016) examples of which includes initializing weights and biases of nodes to improve efficiency in training and computational resources consumption as part of training. Hyperparameters are also set (block 1014) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model.

### Example System and Device

FIG. 11 illustrates an example system 1100 including various components of an example device usable as any type of computing device as described and/or utilized with reference to FIGS. 1-6 to implement examples of the techniques described herein. FIG. 11 illustrates an example system 1100 generally, which includes an example computing device 1102 that is representative of one or more computing systems and/or devices that implement the various techniques described herein. This is illustrated through inclusion of the modeling tool 116. The computing device 1102 is configurable, for instance, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. In one or more examples, a system bus includes any one, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including the hardware elements 1110, which are configurable as processors, functional blocks, and so forth. This includes implementation in hardware as an application specific integrated circuit or other logic device formed using one or more semiconductors. The hardware elements 1110 are not limited by the materials that form the hardware elements 1110, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 1106 is storage media illustrated as including memory/storage 1112. The memory/storage 1112 represents memory/storage capacity associated with one or more computer-readable media. The memory/storage 1112 is configured as a memory component, for example, which is configured to store the digital content 106. The memory/storage 1112 includes volatile media (such as random access memory (RAM)) and/or nonvolatile media, such as read-only memory (ROM), Flash memory, optical disks, magnetic disks, and so forth. The memory/storage 1112 includes fixed media (e.g., RAM, ROM, a fixed hard drive, and so on) as well as removable media, e.g., Flash memory, a removable hard drive, an optical disc, and so forth. The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 1110 include a processing device coupled to the memory component implemented by the memory/storage 1112 to perform operations of the modeling tool 116. The operations, when executed, cause the processing device implemented by the hardware elements 1110 to generate the digital content 106 stored in the memory/storage 1112.

Combinations of the foregoing are also employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (e.g., at least one computing device 1102 and/or processing systems 1104) to implement techniques, modules, and examples described herein.

The techniques described herein are supported by various configurations of the computing device 1102 and are not limited to the specific examples of the techniques described herein. This functionality is also implementable or partially implementable through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data utilized while computer processing is executed on servers that are remote from the computing device 1102. In at least one example, the resources 1118 include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device example, implementation of functionality described herein is distributable throughout the system 1100. The functionality is implementable in part on the computing device 1102 as well as via the platform 1116 that abstracts the functionality of the cloud 1114.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method comprising:
inputting, by a processing device, an object description into a large language model that creates an initial compact graph representing an initial hierarchy of initial object attributes based on the object description;
generating, by the processing device, an initial object model based on the initial compact graph;
inputting, by the processing device, an object edit into the large language model that creates an updated compact graph representing an updated hierarchy of updated object attributes; and
replacing, by the processing device, the initial object model with an updated object model generated based on the updated compact graph.

2. The method of claim 1, wherein the updated compact graph is created by modifying the initial hierarchy or the initial object attributes in response to inputting the object edit and the initial compact graph into the large language model.

3. The method of claim 1, further comprising:
displaying, by the processing device, a user interface at a display device that includes an object preview window including an initial rendered image that depicts a view of the initial object model; and
responsive to receiving the object edit via the user interface, modifying, by the processing device, the object preview window by displaying a subsequent rendered image that depicts an updated view of the updated object model.

4. The method of claim 3, further comprising:
receiving, by the processing device, the object edit by displaying a set of parameter controls indicating adjustable attributes of the initial object model and interpreting the object edit based on user inputs received at the set of parameter controls.

5. The method of claim 1, further comprising:
generating, by the processing device, renderable data that captures a view of the initial object model or the updated object model; and
outputting, by the processing device, a rendered image based on the renderable data for display at a display device.

6. The method of claim 1, wherein the object edit comprises a natural language instruction to modify one or more visual characteristics of the initial object model.

7. The method of claim 1, wherein:
the generating includes interpreting, by the processing device, the initial compact graph by forming an initial set of geometric primitives that are combined into the initial object model; and
the replacing includes interpreting, by the processing device, the updated compact graph by forming an updated set of geometric primitives that are combined into the updated object model.

8. The method of claim 1, wherein the initial object model and the updated object model comprise three dimensional mesh representations of an object.

9. The method of claim 1, wherein the initial object attributes and the updated object attributes comprise geometric properties, material properties, or both geometric and material properties of the initial object model and the updated object model, respectively.

10. A method comprising:
providing, by a processing device, a dataset comprising text descriptions of objects and corresponding compact graphs that represent hierarchies of object attributes;
training, by the processing device, a large language model using the dataset to generate individual compact graphs from text inputs;
fine-tuning, by the processing device, the large language model using synthetic training data generated using a vision language model;
integrating, by the processing device, the large language model with an interpreter that converts the individual compact graphs into corresponding object models; and
generating or editing the corresponding object models based on object descriptions or edit descriptions received as inputs to the large language model.

11. The method of claim 10, further comprising generating the synthetic training data by:
rendering multi-view images of three dimensional models;
captioning the multi-view images using the vision language model; and
generating text descriptions corresponding to the captions using a separate large language model.

12. The method of claim 11, wherein the vision language model comprises a pre-trained Contrastive Language Image Pre-training neural network model, and the captioning the multi-view images comprises:
generating image embeddings for the multi-view images using the pre-trained Contrastive Language Image Pre-training neural network model;
generating text embeddings for a set of candidate captions using the pre-trained Contrastive Language Image Pre-training neural network model; and
selecting captions for the multi-view images based on similarities between the image embeddings and text embeddings.

13. The method of claim 10, wherein the training includes:
obtaining transforms from three dimensional mesh components of the object models that capture spatial relationships and hierarchical structures;
generating procedural compact graphs based on the transforms; and
training the large language model to map between the text descriptions and the procedural compact graphs.

14. The method of claim 10, further comprising:
receiving a text prompt describing a three dimensional object;
generating, using the large language model, a compact graph representing the described three dimensional object;
converting, using the interpreter, the compact graph into a three dimensional mesh; and
rendering an image of the three dimensional mesh for display.

15. The method of claim 14, further comprising:
receiving a text edit instruction describing a modification to the three dimensional object;
modifying, using the large language model, the compact graph based on the text edit instruction;
converting, using the interpreter, the modified compact graph into an updated three dimensional mesh; and
rendering an updated image of the updated three dimensional mesh for display.

16. A system comprising:
a memory component; and
one or more processing devices coupled to the memory component, the processing devices operable to:
create an initial compact graph representing an initial hierarchy of initial object attributes by inputting an object description into a large language model;
generate an initial object model based on the initial compact graph by applying one or more initial geometric transformations that convert the initial compact graph into an initial three dimensional mesh representation;
create an updated compact graph representing an updated hierarchy of updated object attributes by inputting an object edit into the large language model; and
generate an updated object model based on the updated compact graph by applying one or more updated geometric transformations that convert the updated compact graph into an updated three dimensional mesh representation.

17. The system of claim 16, wherein the processing devices are further operable to:
generate synthetic training data by rendering multi-view images of three dimensional models, captioning the multi-view images using a vision language model, and generating text descriptions corresponding to the captions using a separate language model; and
fine-tune the large language model using the synthetic training data to improve performance on out of distribution object categories.

18. The system of claim 16, wherein the initial compact graph and the updated compact graph comprise nodes representing geometric primitives and operations for combining and modifying the geometric primitives.

19. The system of claim 18, wherein the nodes include at least one of: a cylinder node, a rectangle node, a point instance node, a transform node, a fillet node, a fill node, an extrude node, and a join node.

20. The system of claim 16, wherein the processing devices are further operable to:
display a user interface comprising an object preview window and a set of parameter controls;
update the set of parameter controls based on adjustable attributes defined in the initial compact graph; and
interpret user inputs received via the set of parameter controls as object edits for modifying the initial object model.
